(19) United States
(12) Patent Application Publication
(10) Pub. No.: US 2019/0149954 A1
(43) Pub. Date: May 16, 2019

(54) ASSOCIATION OF DIGITAL CONTENT WITH GEOLOCATION TAGS

(71) Applicant: Living Tags, LLC, Lindon, UT (US)

(72) Inventors: Cody Erickson, Orem, UT (US); Lance Nicholes, Lindon, UT (US); Johnny Tanner, Orem, UT (US); David Mitton, Lindon, UT (US); John Bodine, Lindon, UT (US); Ed Rickers, Lindon, UT (US)

(21) Appl. No.: 16/188,111

(22) Filed: Nov. 12, 2018

Related U.S. Application Data
(60) Provisional application No. 62/584,698, filed on Nov. 10, 2017.

(51) Int. Cl. H04W 4/029

(52) U.S. Cl. CPC H04W 4/029; H04W 4/023

(57) ABSTRACT

Systems and methods for associating digital content with geotags are described. A method for associating digital content with geotags may commence with receiving, from a user, the digital content. The method may further include receiving, from the user, data associated with the digital content. The data may include at least a geographical location associated with the digital content. The method may continue with creating a geotag associated with the digital content based on the geographical location. The method may further include determining whether one or more further geotags associated with the user already exist. Based on the determining that the one or more further geotags associated with the user already exist, the geotag may be associated with the one or more further geotags. The method may include presenting a virtual map to the user. The virtual map may include at least the geotag and the one or more geotags.

### CROSS-REFERENCE TO RELATED APPLICATION

The present utility patent application is related to and claims the priority benefit under 35 U.S.C. 119(e) of U.S. provisional application No. 62/584,698, filed on 10 Nov. 2017, and titled “SYSTEMS AND METHODS FOR ASSOCIATING DIGITAL CONTENT WITH GEOLOCATION TAGS.” The disclosure of this related provisional application is incorporated herein by reference for all purposes to the extent that such subject matter is not inconsistent herewith or limiting hereof.

### TECHNICAL FIELD

The present disclosure relates generally to data processing and, more particularly, to associating geolocation tags with digital content.

### BACKGROUND

Geolocation tags, also referred to herein as geotags, are widely used for associating media files with geographical locations. Geotagging can be performed by imbedding geographical identification metadata into the media files. The geographical identification metadata may include latitude and longitude coordinates, as well as time stamps, altitude, and any other related data.

Geotagging can be used by users of mobile devices to find location-specific information. Specifically, a user can use the location information to search for images, videos, and events associated with the location. Additionally, the user may add geographical metadata to images or videos taken at various locations and create a virtual map of the locations. Furthermore, the user may use geotagging for determining locations of objects shown in images, for example, locations of places of interest, nature, and the like. However, even after assigning geotags to media files, the resulting list may not be sufficiently informative of user interests and travel experiences.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

Provided are systems and methods for associating digital content with geotags. In some example embodiments, a method for associating digital content with geotags may commence with receiving, from a user, digital content. The method may further include receiving, from the user, data associated with the digital content. The data may include at least a geographical location associated with the digital content. The method may continue with creation of a geotag associated with the digital content based on the geographical location. The method may further include determining whether one or more further geotags associated with the user already exist. Based on the determining that the one or more further geotags associated with the user already exist, the geotag may be associated with the one or more further geotags. Thereafter, the method may continue with presenting a virtual map to the user. The virtual map may include at least the geotag and the one or more geotags.

According to some embodiments of the disclosure, a system for associating digital content with geotags may include a processor and a database in communication with the processor. The processor may be configured to receive, from a user, the digital content. The processor may be further configured to receive, from the user, data associated with the digital content, with the data including at least a geographical location associated with the digital content. The processor may be configured to create a geotag associated with the digital content based on the geographical location. The processor may be further configured to determine whether one or more further geotags associated with the user already exist. Based on the determining that the one or more further geotags associated with the user already exist, the processor may associate the geotag with the one or more further geotags. The processor may be configured to present a virtual map to the user. The virtual map includes at least the geotag and the one or more geotags.

Other example embodiments of the disclosure and aspects will become apparent from the following description taken in conjunction with the following drawings.

### BRIEF DESCRIPTION OF THE DRAWINGS

Embodiments are illustrated by way of example and not limitation in the figures of the accompanying drawings, in which like references indicate similar elements.

FIG. 1 illustrates an environment within which systems and methods for associating digital content with geotags can be implemented, according to an example embodiment.

FIG. 2 is a block diagram showing various modules of a system for associating digital content with geotags, in accordance with certain embodiments.

FIG. 3 is a process flow diagram showing a method for associating digital content with geotags, according to an example embodiment.

FIG. 4 shows a user interface illustrating a welcome page, according to an example embodiment.

FIG. 5 illustrates a user interface showing options available to a user, according to an example embodiment.

FIG. 6 shows a user interface for enabling the user to upload the digital content, according to an example embodiment.

FIG. 7 shows a user interface for creating a webpage to be associated with a deceased person, according to an example embodiment.

FIG. 8 illustrates a user interface showing digital content, in accordance with an example embodiment.

FIG. 9 illustrates a user interface showing digital content for which a geographical location and a date are entered by a user, in accordance with an example embodiment.

FIG. 10 shows the virtual map presented to a user, according to an example embodiment.

FIG. 11 illustrates a user interface showing a list of online communities, according to an example embodiment.

FIGS. 12A-12E illustrate user interfaces showing example online communities, according to an example embodiment.

FIG. 13 illustrates a user interface showing an online community, according to an example embodiment.

FIG. 14 illustrates a user interface showing digital content associated with an online community, according to an example embodiment.

FIG. 15A shows a code associated with digital content, according to an example embodiment.

FIG. 15B shows a code engraved on a plate, according to an example embodiment.

FIG. 16 shows a memorial tablet created for a person using a physical geotag, according to an example embodiment.

FIG. 17 illustrates a user interface showing an example search performed based on key words.

FIG. 18 illustrates a user interface showing templates of an online community, according to an example embodiment.

FIG. 19 shows a diagrammatic representation of a computing device for a machine in the exemplary electronic form of a computer system, within which a set of instructions for causing the machine to perform any one or more of the methodologies discussed herein can be executed.

### DETAILED DESCRIPTION

The following detailed description includes references to the accompanying drawings, which form a part of the detailed description. The drawings show illustrations in accordance with exemplary embodiments. These exemplary embodiments, which are also referred to herein as “examples,” are described in enough detail to enable those skilled in the art to practice the present subject matter. The embodiments can be combined, other embodiments can be utilized, or structural, logical, and electrical changes can be made without departing from the scope of what is claimed. The following detailed description is, therefore, not to be taken in a limiting sense, and the scope is defined by the appended claims and their equivalents.

The present disclosure is directed to associating digital content with geotags. In one example embodiment, a system for associating digital content with geotags may be implemented on a plurality of platforms, websites, or mobile applications. A user may access a website associated with the system and create a user profile on the website. During the registration process, the user may provide user data to the system, such as an email, a phone number, links to profiles of the user in social networks, and any other user-specific data. The user may further provide digital content to the system. The digital content may include media files, such as text, images, graphics, audio files, video files, and so forth. The user may further provide data associated with the digital content, in particular, a geographical location associated with the digital content. Specifically, upon uploading the digital content to the system, the user may be prompted to select the geographical location associated with the digital content. To facilitate the selection process, a map can be provided to the user so that the user can create a location identifier to identify the geographical location. Furthermore, the user may be able to provide textual input and manually type the name of the place associated with the digital content. The system may perform a search based on the data entered by the user and provide a list of presumptive locations associated with the place entered by the user and corresponding geographical locations. The user may make a selection using the list of the places that correspond to the place entered by the user. The geographical location of the selected place can be assigned to the geographical location of the digital content. In some embodiments, the user may manually input geographic coordinates of the place related to the digital content.

Upon receipt of the geographical location of the digital content, the system may create a geotag for the digital content. The geotag may store data related to the geographic location of the digital content and may further store any metadata related to the digital content, such as a title, a description, a link to the website on which the media content is published, and so forth. The system may associate the geotag with a virtual map and may present the virtual map with the geotag to the user. Additionally, the system may determine, based on the received digital content, whether any other geotags of the user exist in a database associated with the system. In other words, the system may determine whether the user has previously uploaded any other digital content to the system. All digital content can be marked with geotags, thus finding of the other digital content may result in finding other geotags of the user that are already known to the system. The system may associate the geotag of the digital content with the one or more further geotags relating to other digital content previously uploaded by the user. In other words, all geotags related to the digital content of the user may be tied to each other. The virtual map displayed to the user may include all the geotags related to all the digital content uploaded the user.

In an example embodiment, the user may use the system to create an online collection of media, in which a geotag is created for each media file and in which all geotags related to the user are associated with each other. Therefore, other users may be able to review all of the geotags of the user on a virtual map.

Additionally, the user may be able to create one or more online communities. Specifically, an online community may have multiple landing pages associated with respective people, events, places, and so forth. In some embodiments, the online community may have a webpage associated with the user who created the online community. The user who created the online community may also be an administrator for the online community. The administrator may invite other users to join the online community as community members. Alternatively, other users may be able to join the online community without receiving any requests. The administrator may upload, to the webpage, multimedia digital content to be associated with the online community. The administrator can assign permissions (and/or a shared login) to other users, thereby making the other users collaborators of the online community such that the other users can also upload the multimedia digital content to be associated with the online community. The administrator may decide whether to allow the additional content to be published to the online community. Additionally, the administrator can allow community members to post comments concerning the content of the online community. The administrator can decide, with regard to the content posted by the community members, whether to allow or disallow comments posted to the online community. Multiple geotags associated with the particular community may be associated with each other using a “geotying” feature of the system. The administrator can choose whether a geotag is visible to the community members.

Once a user or a community member launches the webpage, a landing page of the online community may be shown to the user. The landing page may include a listing of the closest public geotags associated with the online community.

When a geotag associated with the user or the online community is determined by the system to be nearby, i.e., within a predetermined distance, an automatic push notification may be provided to a digital device of the user or members of the online community (assuming the user set a status of a nearby geotag to public, i.e., allowed to be shown to anyone or to all members of the online community). When a community member is traveling, the system may provide an automatic push notification when the community member is near a geotag associated with the online community. This approach eliminates the need for the community member to scan a Quick Response (QR) code of a physical geotag (described in more detail below).

In various embodiments, geotags can be both physical or virtual. Thus, a user or a community member can visit geotags of other users in person or view the geotags online.

In general, the system for associating digital content with geotags may be utilized by individuals to create digital profiles, maps, and visual timelines by uploading photos, videos, documents, and text relating to the life of users, and create chronicles of their personal story as a living memory. The system can further allow users to share their digital stories created with a plurality of digital media. The users can be allowed to include other users in the building/editing of their online community. The access may be provided by using a shared login, by sending an invitation to other users to join the online community, and the like. The viewers of the online community can comment on the online community generally or on any picture or video specifically. The viewers can also upload text, audio, photos, and videos of their own that the viewers would like to publish in the online community. The owner of the online community, also referred herein to as a custodian or administrator of the online community, may be notified of any new comments and may have the ability to accept or decline the comments, photos, videos, and so forth.

The users may also leave voice recordings for each photo and video of the online community. The audio message may be saved on the page of the photo or the video. All images and videos of the online community can be associated with a geotag. Therefore, any digital content added to the online community can be geotagged with specific location information. In other words, pictures, videos, and so forth may not only include a description, but can also be geotagged to build a living roadmap for the online community. The users may not have to scan the actual geotag, i.e., a physical geotag, to see the digital content of the online community because any location that is geotagged is also shown via a mobile application associated with the system. Therefore, the users can click on the geotagged location, picture, and so forth to see all digital media related to the online community. When the user is at a location of the physical geotag, the user may scan the physical geotag. The mobile application may include a scanner so that the user can scan a geotag (e.g., a physical geotag or a printed geotag) using the mobile application.

Any digital content uploaded by the user as public digital content can be automatically added to the online community of the user. Once the user launches the mobile application, the online community is shown to the user as a landing page of the mobile application. The landing page may include a listing of the closest geotags to the current location of the user.

The users may be associated with a plurality of pages related to multiple online communities. The user may search the online communities by the closest geotags, trending geotags, category geotags, and so forth. The user may search by a name to find a specific geotag (e.g., ‘Jane Smith’) or by any key word that is included in a description of the geotag (e.g., ‘all veterans’).

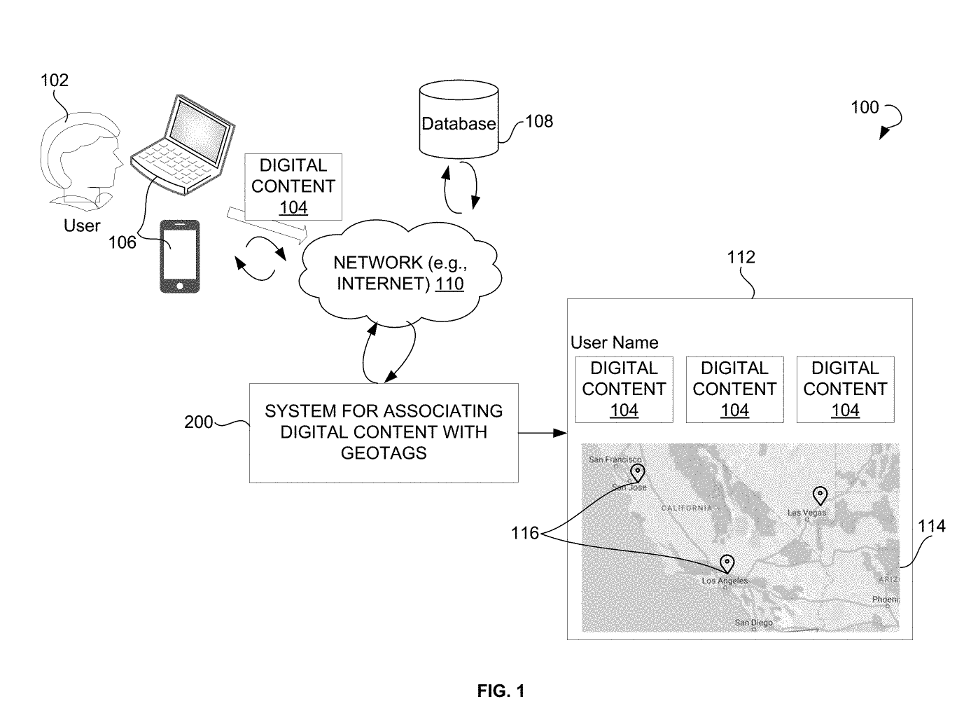

Referring now to the drawings, FIG. 1 is a block diagram showing an example environment 100 within which a method and system for associating digital content with geotags can be implemented. The example environment can include a user 102 that provides digital content 104 using a graphical user interface (GUI) of a digital device 106 associated with the user 102, a system 200 for associating digital content with geotags (also referred to as a system 200), a database 108 in communication with the system 200, and a network 110. The GUI can be part of the system 200. The user 102 may be connected to the system 200 via the network 110.

The network 110 can include the Internet or any other network capable of communicating data between devices. Suitable networks can include or interface with any one or more of, for instance, a local intranet, a Personal Area Network, a Local Area Network, a Wide Area Network, a Metropolitan Area Network, a virtual private network, a storage area network, a frame relay connection, an Advanced Intelligent Network connection, a synchronous optical network connection, a digital T1, T3, E1 or E3 line, Digital Data Service connection, Digital Subscriber Line connection, an Ethernet connection, an Integrated Services Digital Network line, a dial-up port such as a V.90, V.34 or V.34bis analog modem connection, a cable modem, an Asynchronous Transfer Mode connection, or a Fiber Distributed Data Interface or Copper Distributed Data Interface connection. Furthermore, communications can also include links to any of a variety of wireless networks, including Wireless Application Protocol, General Packet Radio Service, Global System for Mobile Communication, Code Division Multiple Access or Time Division Multiple Access, cellular phone networks, Global Positioning System, cellular digital packet data, Research in Motion, Limited duplex paging network, Bluetooth radio, or an IEEE 802.11-based radio frequency network. The network can further include or interface with any one or more of an RS-232 serial connection, an IEEE-1394 (Firewire) connection, a Fiber Channel connection, an IrDA (infrared) port, a Small Computer Systems Interface (SCSI) connection, a Universal Serial Bus connection or other wired or wireless, digital or analog interface or connection, mesh or Digi® networking. The network 110 can be a network of data processing nodes that are interconnected for the purpose of data communication. The network 110 may include any suitable number and type of devices (e.g., routers and switches) for forwarding commands, content, and/or requests from each user 102 to the system 200 and responses back to the user 102.

The digital device 106 of the user 102 may include a mobile phone, a computer, a laptop, a smart phone, a tablet personal computer (PC), and so forth. The user 102, in some example embodiments, can include a person interacting with the GUI via the digital device 200. The user 102 can be registered with the system 200.

Upon receiving the digital content 104 from the user 102, the system 200 may create a webpage 112 associated with the user. A virtual map 114 may be displayed on the webpage 112. The virtual map 112 may have a plurality of geotags 116 associated with the digital content 104 uploaded by the user 102.

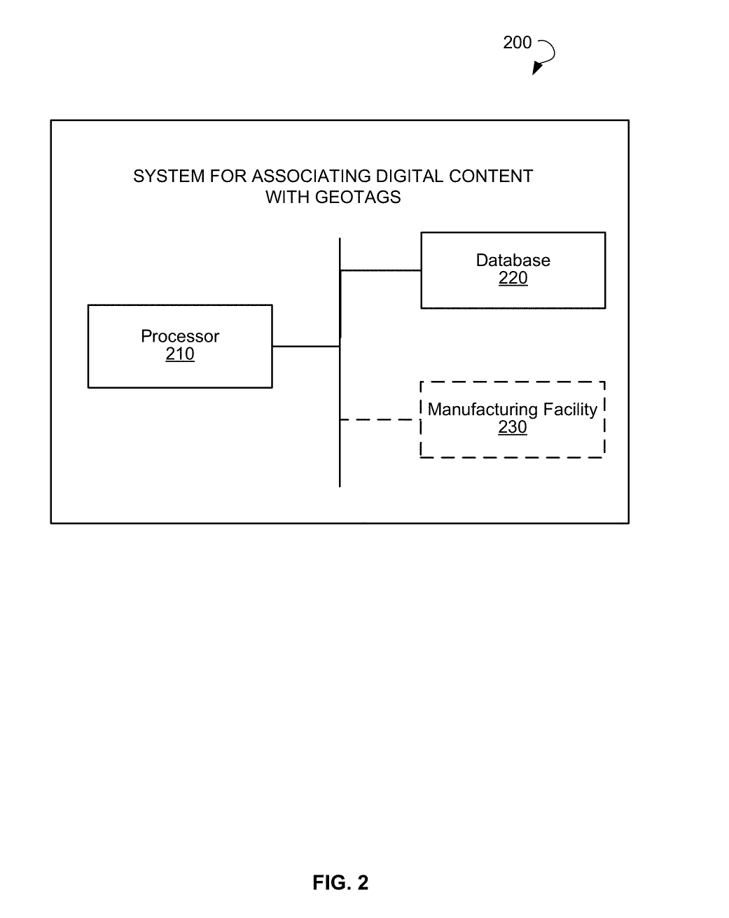

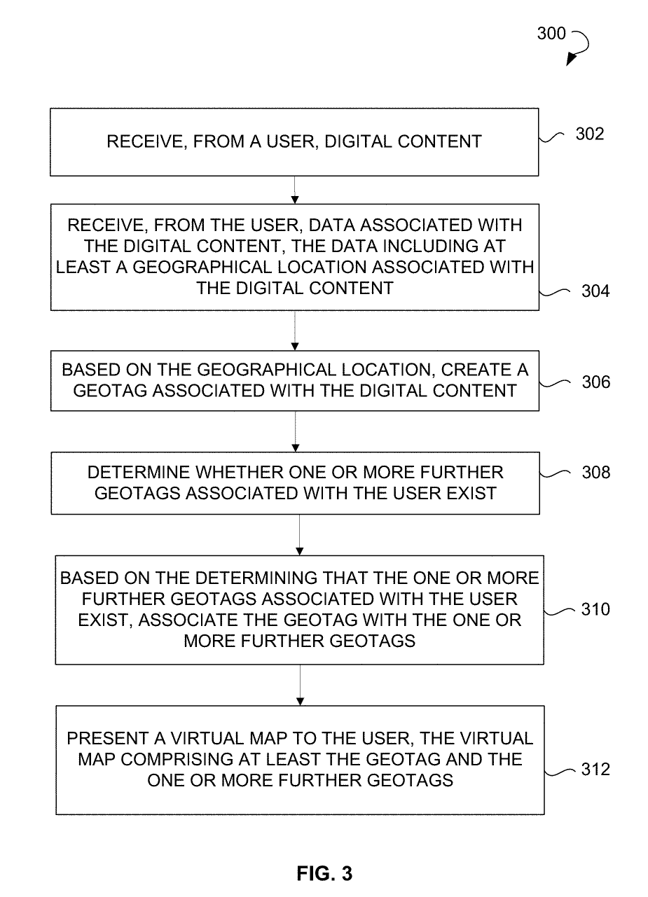

FIG. 2 shows elements of a system 200 for associating digital content with geotags, according to an example embodiment. The system 200 may include a processor 210, a database 220, and, optionally, a manufacturing facility 230. The database 220 may include computer-readable instructions for execution by the processor 210. The processor 210 may include a programmable processor, such as a microcontroller, central processing unit (CPU), and so forth. In other embodiments, the processor 210 may include an application-specific integrated circuit or programmable logic array, such as a field programmable gate array, designed to implement the functions performed by the system 200. The operations performed by the elements of the system 200 are described in detail with reference to FIGS. 3-18.

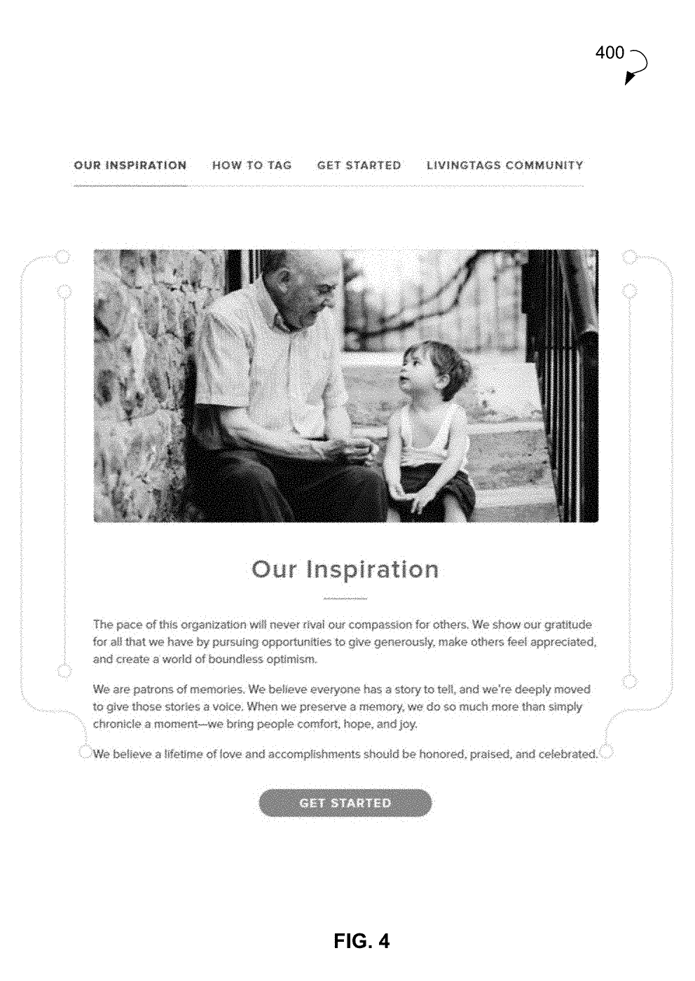

FIG. 3 is a flow diagram showing a method 300 for associating digital content with geotags, according to an example embodiment. The method 300 may commence with the user opening a website or a mobile application associated with a system for associating digital content with geotags. FIG. 4 shows a user interface illustrating a welcome page 400 that may be shown to the user when the user opens the website or the mobile application, according to an example embodiment. Any notification or an instruction for the user to perform actions may be shown on the welcome page. In other example embodiments, other pages may be displayed to the user upon opening of the website or the mobile application.

In an example embodiment, the user may register with the system by providing user data, such as a login, password, and any other user-related data. Based on the data provided by the user, a user profile may be created for the user. The method 300 may continue with receiving, from a user, the digital content at operation 302 shown on FIG. 3. In an example embodiment, the digital content may include one or more of the following: text, images, graphics, audio files, video files, and so forth.

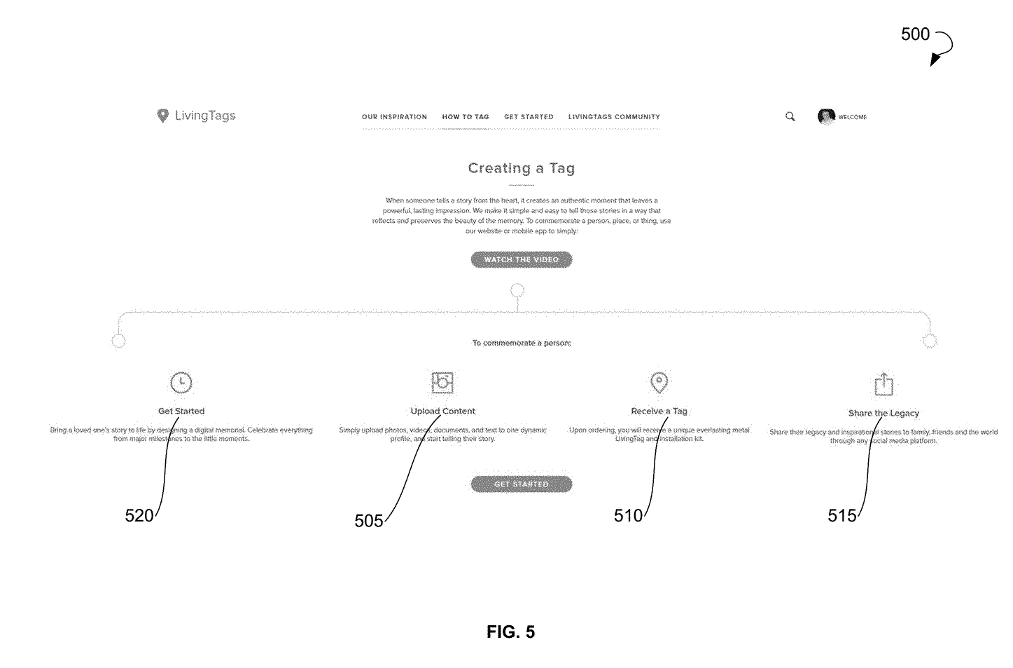

FIG. 5 illustrates an example user interface 500 showing options available to the user, according to an example embodiment. Specifically, the user may upload digital content using a button 505, receive a physical geotag related to the uploaded digital content using a button 510, share the digital content with other users of the system using a button 515, obtain more information on how to use the system using a button 520, and so forth.

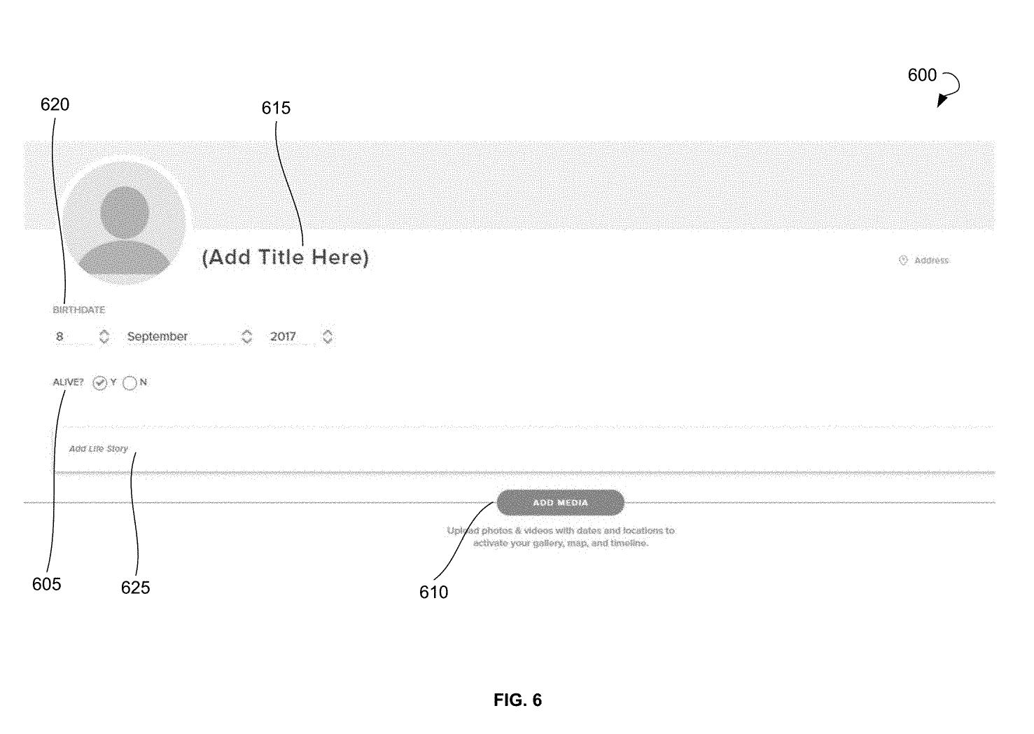

When the user selects “upload content” button 505, a user interface shown on FIG. 6 may be rendered. FIG. 6 shows an example user interface 600 for enabling the user to upload the digital content, according to an example embodiment. Specifically, FIG. 6 shows the user interface 600 for creating a webpage to be associated with a person, a group of people, an event and the like, and uploading the digital content related to the person, the group of people, and the event. The webpage 600 may be configured as an online community, to which the user may upload the digital content. Furthermore, the user may authorize other users to upload the digital content related to the person or the event related to the online community. Other users can be allowed to download the digital content and can be referred to as “collaborators.” For example, if the user creates an online community devoted to a grandfather of the user and allows collaborators to upload the digital content to the online community, the collaborators may upload images or videos related to the grandfather of the user. The images or videos may relate to a place where the grandfather worked, places the grandfather visited, favorite places, and the like.

In an example embodiment, a user creating the online community may be an administrator or worker of a funeral home or cemetery that works with families of deceased persons. In this embodiment, the user may create a webpage or an online community for a deceased family member. The user associated with the funeral home may sign up as a partner for associating digital content with geotags. Specifically, the user may visit a website associated with the system, click on the ‘Partner Portal’ link, and provide appropriate login and password information. The user may then set up a user profile by providing a name of the funeral home, contact information, billing details, logo of the funeral home, and the like. Once the user profile is created, the user may create a webpage associated with the deceased person, e.g., by clicking on the ‘Create a Webpage’ link. Upon creation of the webpage, the user may input the appropriate information, such as a name, birth date, death date, digital media, obituary, cemetery location, cemetery details, and so forth. The user may automatically receive a digital copy of the webpage related to the deceased person. The digital copy of the webpage can be printed on a funeral booklet, emailed to the family members of the diseased person, scanned, and so forth. In an example embodiment, the digital copy of the webpage may be provided in the form of an identifier, such as a QR code, barcode, and linear code, scannable by a digital device. Upon scanning the code, the user may be directed to the webpage that relates to the deceased person storing the digital content.

The webpage created by the administrator of the funeral home can be an online community associated with the diseased person. The online community can serve as a digital guestbook associated with the diseased person. The family members or other users related to the diseased person may be provided with access to the webpage. Specifically, the administrator may invite other users, such as family members and persons related to the diseased person, to join the online community as community members. Alternatively, other users may be able to join the online community without receiving any invitations. Other users may add additional content, geographical locations, and information related to the diseased person to the webpage, post comments concerning the content of the online community, and so forth.

In an example embodiment, the digital content received from the user may be associated with the user profile, for example, by assigning, to the digital content, a unique identifier associated with user data. In an example embodiment, the created webpage 600 can also be associated with the user profile by assigning, to the webpage 600, the unique identifier associated with user data.

In some example embodiments, the method 300 can include receiving, from the user, a request to create an online community. In response to the request, the online community associated with the user can be created by generating the webpage 600 associated with the online community. In some embodiments, creating the webpage 600 to be associated with a person, a group of people, an event, and the like, may include creating the online community; i.e., the created webpage 600 may be associated with the online community. The user may provide data associated with one or more further users to be associated with the online community. The user and the one or more further users may be able to upload and review digital content of the webpage 600 associated with the online community. The digital content uploaded by the user and the one or more further users may be published on the webpage 600 associated with the online community.

Additionally, the user may be able to select a status category to be assigned to the digital content. The status category may include a private category and/or a public category. The digital content having the private category may be presented for review by the user, whereas the digital content having the public category may be presented for review by a plurality of users.

If the user creates the webpage associated with a living person, such as the user himself, a relative, or a friend of the user, the user may select “alive” option 605 on the user interface on the webpage 600 and enter a birthday date of the person.

The user may upload the digital content upon pressing an “add media” button 610. The method 300 may continue with receiving data associated with the digital content from the user at operation 304 shown on FIG. 3. The data associated with the digital content may include a geographical location associated with the digital content. Additionally, the user may provide further data related to the digital content. Specifically, the user may enter a title 615 (a name of a person, name of an event, name of a group of persons, and so forth), a birth date 620, and a description 625, such as a life story of the person related to the digital content.

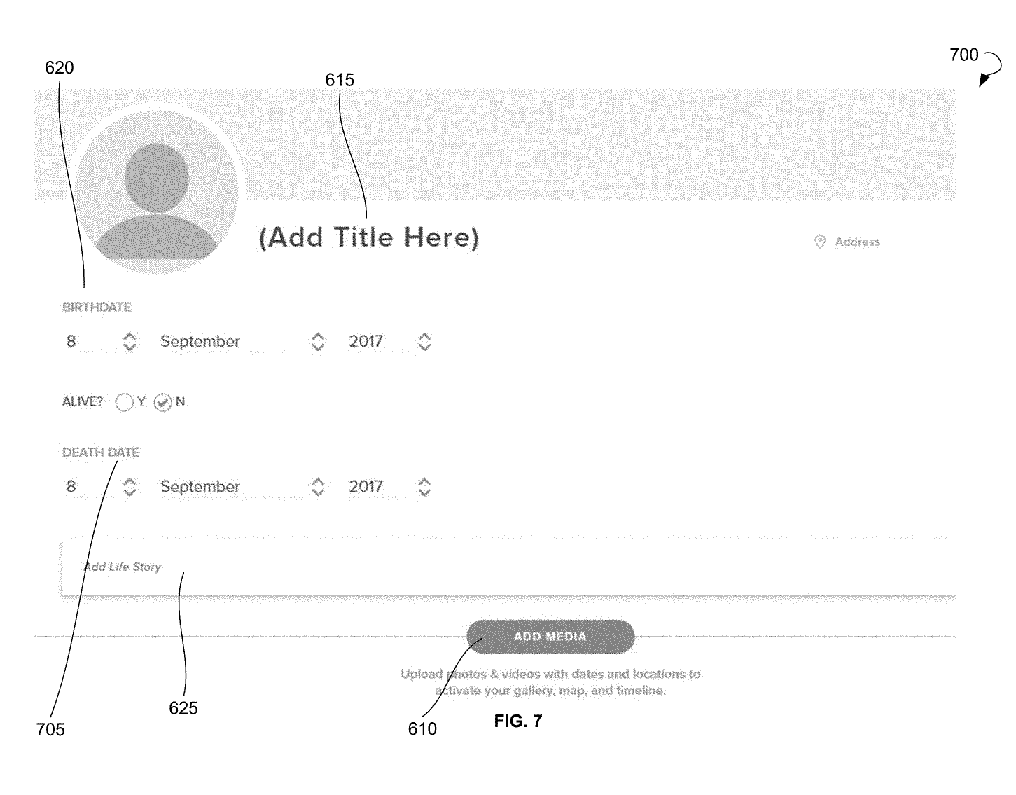

FIG. 7 shows an example user interface 700 for creating a webpage to be associated with a deceased person, according to an example embodiment. The user may enter a death date 705 of the deceased person.

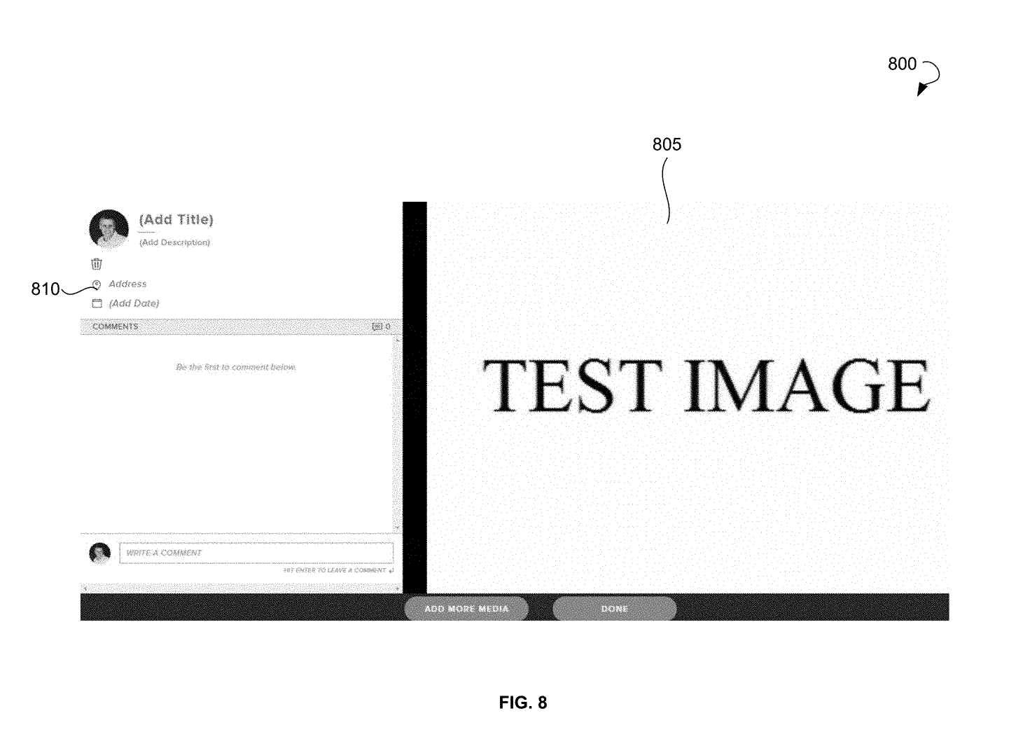

FIG. 8 illustrates a user interface 800 showing the digital content 805, in accordance with an example embodiment. The digital content 805 may include an image uploaded by the user. In an example embodiment, the user may be prompted to enter the geographical location 810 associated with the digital content 805.

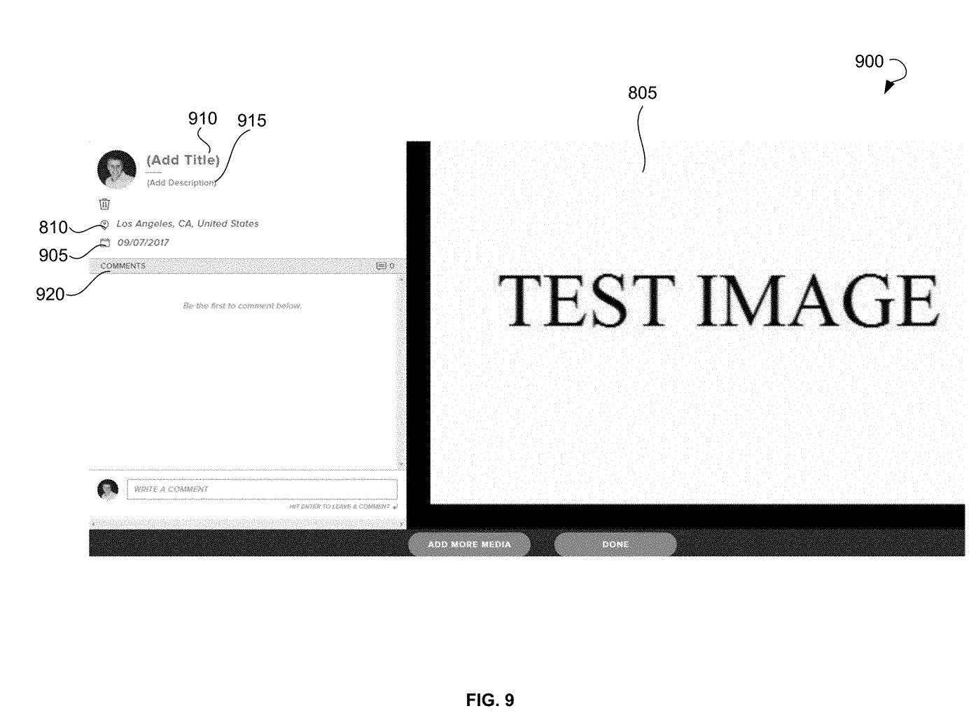

FIG. 9 illustrates a user interface 900 showing the digital content 805 for which the geographical location 810 and a date 905 are entered by the user. Additionally, the user may add a title 910 of the image, a description 915, and may write a comment 920 for the image.

The method 300 may further include creating a geotag associated with the digital content at operation 306 shown on FIG. 3. The geotag may be created based on the geographical location entered by the user. The method 300 may further include determining whether one or more further geotags associated with the user already exist at operation 308 shown on FIG. 3. In an example embodiment, the determining whether the one or more further geotags associated with the user already exist may include determining user data associated with the user, such as a unique identifier associated with the user. The digital content may be associated with the unique identifier of the user. Based on the unique identifier, the system may search for the one or more further geotags associated with the unique identifier of the user. Based on the search, the one or more further geotags associated with the unique identifier of the user may be selected as the one or more further geotags that already exist.

The method 300 may continue with associating the geotag with the one or more further geotags at operation 310 shown on FIG. 3. The association of the geotag with the one or more further geotags may be performed based on the determining that the one or more further geotags associated with the user already exist.

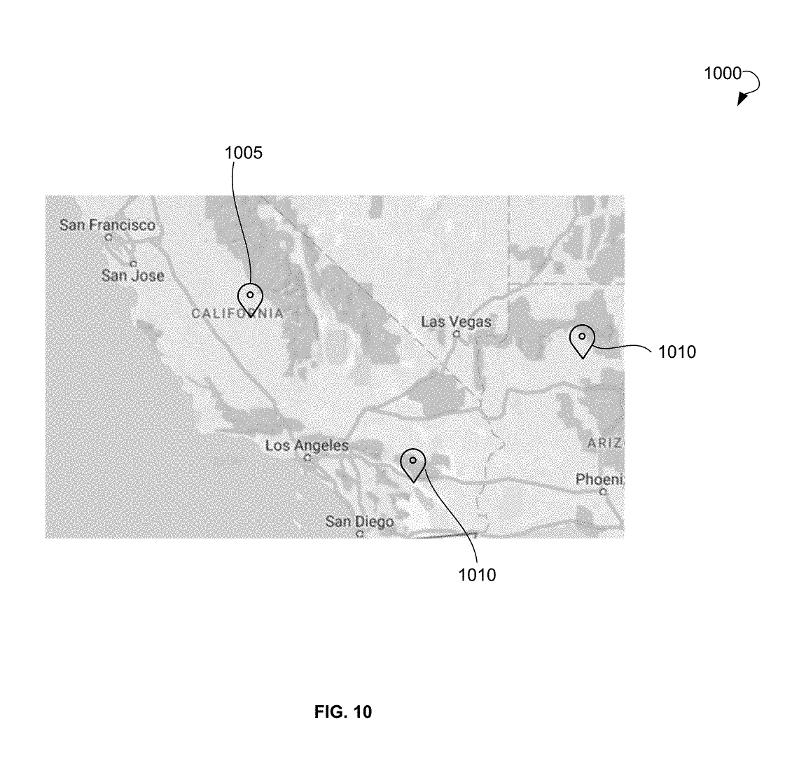

The method 300 may further include presenting a virtual map to the user at operation 312 shown on FIG. 3. FIG. 10 shows a virtual map 1000 presented to the user, according to an example embodiment. The virtual map 1000 may include at least a geotag 1005 associated with the uploaded digital content and one or more geotags 1010 associated with digital media previously uploaded by the user.

Additionally, if it is determined that the further one or more geotags associated with the user do not exist, the geotag 1005 may be designated as a first geotag associated with the user. The geotag 1005 may be used for associating with subsequent geotags associated with the user upon receipt, from the user, of further digital content associated with the subsequent geotags.

Additionally, the user may provide a request to edit the digital content. The request may include an instruction to crop the digital content, rotate the digital content, edit, change design of the digital content, change color of the digital content, remove a portion of the digital content, preview the digital content, and so forth. The system may also be connected to audio and video players, such as a JW player, to help the user to manage and transcode audio and video.

In an example embodiment, the user profile may be associated with one or more social media profiles of the user. Specifically, the user may provide data associated with social media profiles of the user in one or more social networks. The user may also provide a request to post the digital content to a timeline associated with the one or more social media profiles. Based on the request of the user, the digital content may be posted to the timeline associated with the one or more social media profiles of the user. Additionally, the user may share the digital content or a link to the online community via email, text messages, and so forth.

In an example embodiment, the digital content may be pulled from the one or more social media profiles. Specifically, the user may select the digital content published in the social media profile of the user or in the social media profile of any other user of the social network. The selected digital content may be uploaded from the social media profile to the user profile of the system for associating digital content with geotags.

The term “pulling” means uploading information from the social media profile of the user into the user profile or online community associated with the system in order to associate digital content with geotags. The information pulled from the social media profile may include a picture, video, audio file, or text that the user posted on a timeline or in the user profile of social media, such as Facebook, Instagram, Twitter, and so forth.

In an example embodiment, a plurality of geotags associated with a plurality of users may be displayed on the virtual map 1000 to the user. The user may select a geotag associated with a further user. Based on the selection, a virtual map associated with the further user may be displayed to the user. The virtual map associated with the further user may include a plurality of geotags associated with the further user.

In a further example embodiment, the method 300 may include continuously receiving a geographical location of a digital device associated with the user. Specifically, the mobile application running on the digital device of the user may track the geographical location of the digital device. The mobile application may constantly send the geographical location of the digital device to a server in communication with the system. The server may store a map of geographical locations associated with the digital content. Alternatively, the map of geographical locations associated with the digital content may be stored on the mobile application so that the mobile application does not need to send the geographical location of the digital device to the server. The server or the mobile application may compare the geographical location of the digital device with the map of geographical locations associated with the digital content. When it is determined that a current geographical location of the digital device associated with the user is in proximity to the geographical location associated with the digital content, an alert may be sent to the digital device of the user. The alert may notify the user that the current geographical location of the digital device is within a proximity of the geographical location associated with the digital content. The alert may additionally include the virtual map showing the geotag associated with the digital content. The alert may be provided in the form of a pop-up message shown on the digital device of the user when the user is near the physical location of the geographic coordinates associated with geotags in the system.

For example, when a person who is a member of the online community is traveling, the mobile application related to the system can update the geographical location of the person to determine the closest geotags. The person does not need to scan the QR code provided at the geographical location because when the person approaches a geotagged location, the mobile application may provide a pop-up message.

In an example embodiment, when a person who created the online community is traveling, the online community may become a personal mobile online community of the person. For example, when the person visits another city and makes a geotag associated with that city or a location or an event in the city, the citizens of the city who are users of the mobile application of the system may see the geotag created by the user. Additionally, the users may view all other geotags of the user. Therefore, the online community of the user may represent a current journal/life history of the user. For example, if the user makes a geotag public, people in a proximity of the user can see this public geotag and all public geotags of the user.

Specifically, the “geotying” feature of the system (i.e., assigning a geotag to the digital content and displaying geotags of the user to other users at a place where the user is currently located) and “online community” functionality are used to support the mobile online community of the user. The personal online community (also known as a Roving Community) of the user and the information that the user wants to share about himself follow the user wherever the user travels and the online community moves to places where the user is located. Specifically, the geotags of the online community can be displayed to other users located at the place the user is currently located. For example, the user may have a personal online community and make certain information available to the public in general and accessible to other users, such as information describing the person as an attorney that specializes in patent law, information related to hobbies, likes, dislikes, information concerning an apartment for rent, and the like. For, example, the user may travel to New York for a conference. The Roving Community may be associated with the location of the conference, and any user at the location can see all the information the user made public in the personal online community. The mobile online community may be associated with the location of the conference, and any user at the location can see geotags related to the personal online community of the user on the map and view the personal online community and all the information the user made public in the personal online community.

Therefore, the geotags associated with the user may be viewed at any location where the user is currently located. Specifically, people at a location where the user is currently located may view all geotags of the user and, thus, may learn more information about the user. Upon creation of a geotag at any location by the user, other users in proximity to the location may learn more about the user by viewing the geotag related to the location and all other geotags of the user.

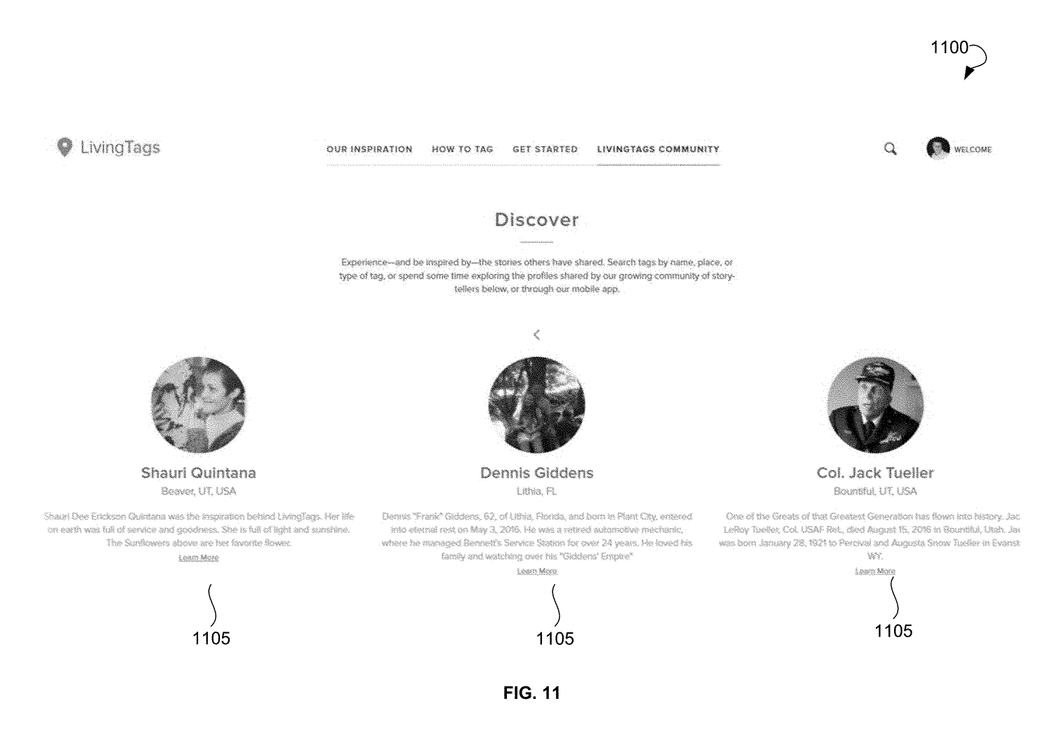

FIG. 11 illustrates a user interface 1100 showing a list of online communities 1105. The online community 1105 may be associated with a living person, a deceased person, a group of persons (e.g., deceased family members), an event, and so forth. The list of online communities may include a title of the online community, a description, an image, and so forth. The user may select one of the online communities 1105 to review the selected online community.

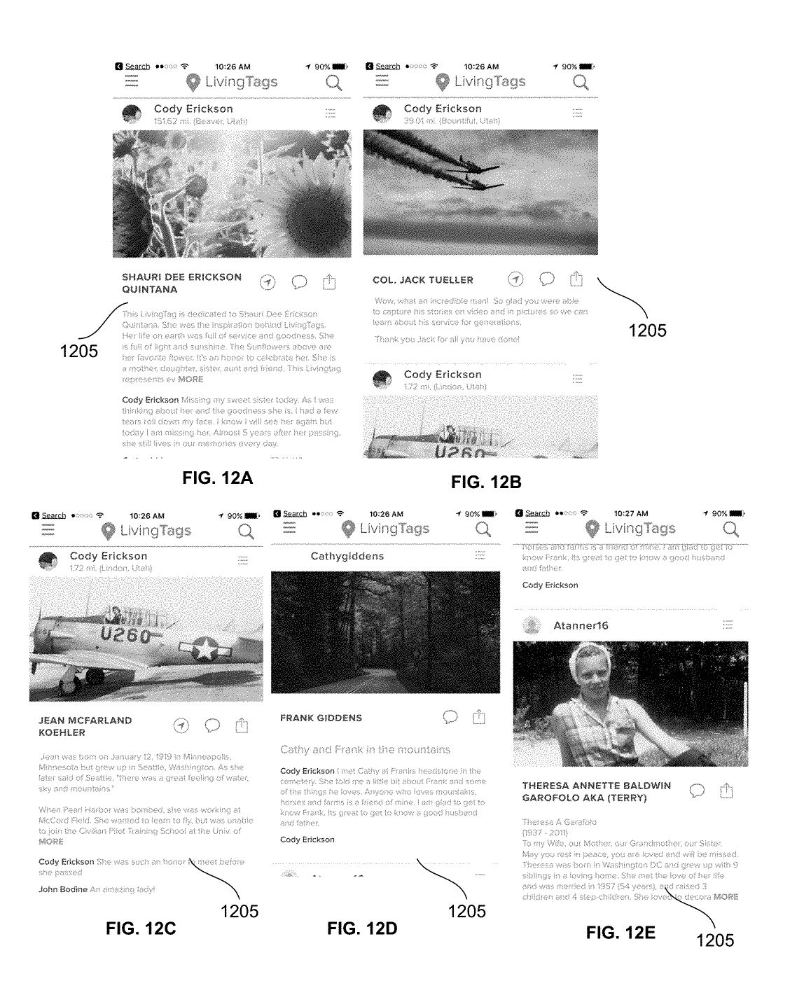

FIGS. 12A-12E illustrate user interfaces showing example online communities 1205. Each of the online communities of FIGS. 12A-12E can be associated with a person and may include a name of the person, digital content associated with the user profile, and geotags associated with the digital content of the online community. The online community 1205 may have a plurality of items of digital content. The items of the digital content, such as a picture and text related to the picture, may be displayed in a form of posts in the online community.

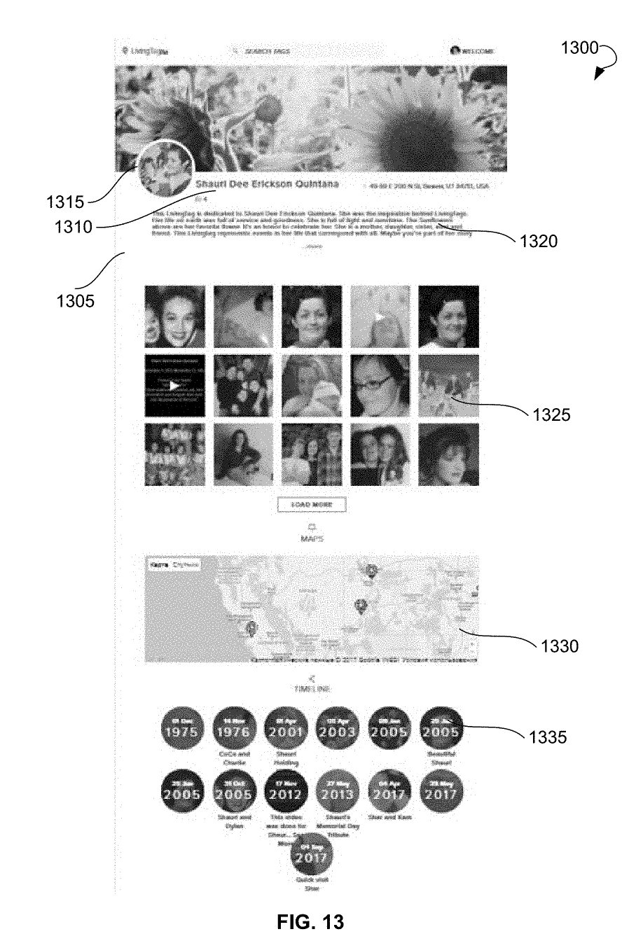

FIG. 13 illustrates a user interface 1300 showing another example online community 1305, according to an example embodiment. The online community 1305 of FIG. 13 is associated with a person and may include a name 1310 of the person, an image 1315, a description 1320, a list 1325 of digital content items associated with the online community 1305, and a digital map 1330 showing geotags associated with the digital content of the online community 1305. The online community 1305 may further include a timeline 1335 of the digital content showing files of the digital content according to dates associated with the digital content. In an example embodiment, the timeline 1335 can be automatically created by the system based on the dates provided by the user when uploading digital content to the online community 1305.

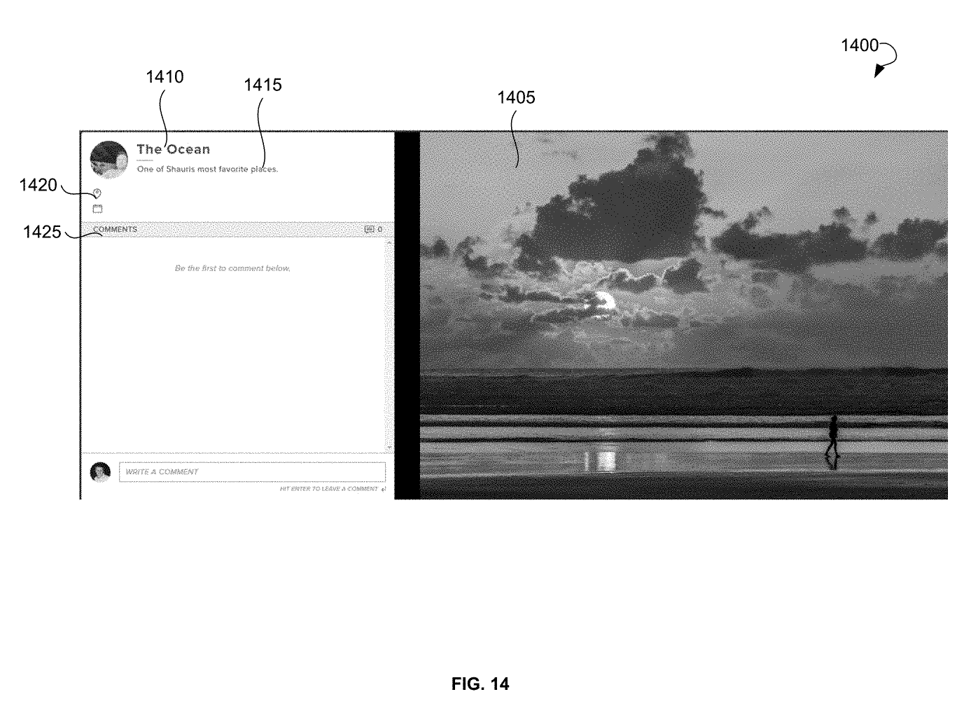

FIG. 14 illustrates a user interface 1400 showing digital content 1405, namely an image, associated with the online community, according to an example embodiment. The digital content 1405 may have a title 1410, a description 1415, and a geotag 1420. Further users of the system may review the digital content 1405 and provide comments 1425.

In an example embodiment, the user may provide a request for manufacturing a physical geotag associated with the geotag. In response to the request, the physical geotag associated with the geotag may be manufactured. The physical geotag may be manufactured at a manufacturing facility associated with the system or a third-party manufacturing facility. An article of manufacture integrating the physical geotag may be made of metal, such as aluminum, and so forth. The article may have rectangular, round, square, oval, and any other shape. An identifier associated with the geotag may be physically embedded into the article. The identifier may include at least a code. The code may include a QR code, a barcode, and a linear code. The code may be scannable by a digital device. The code may be associated with a web resource that stores the digital content. For example, the code may contain a link to the web resource. The user may attach the physical geotag to a physical object. A geographical location of the physical object may be the same as the geographical location associated with the digital content uploaded by the user.

In a further example embodiment, a digital geotag, namely a digital version of the physical geotag, can be produced. The digital geotag can be scanned, similarly to the physical geotag, and emailed, printed, or shared via social media. The digital geotag may include a key component in a partner model (when a user registers with the system as a partner), as the user may print the digital geotag whenever there is a need. For example, the user may print the digital geotag on a funeral brochure including a digital geotag for the attendees to scan. Upon scanning the digital geotag, content from a web resource storing the digital content associated with the diseased person can be provided to the user via a user device, similarly to scanning the physical geotag at the gravesite.

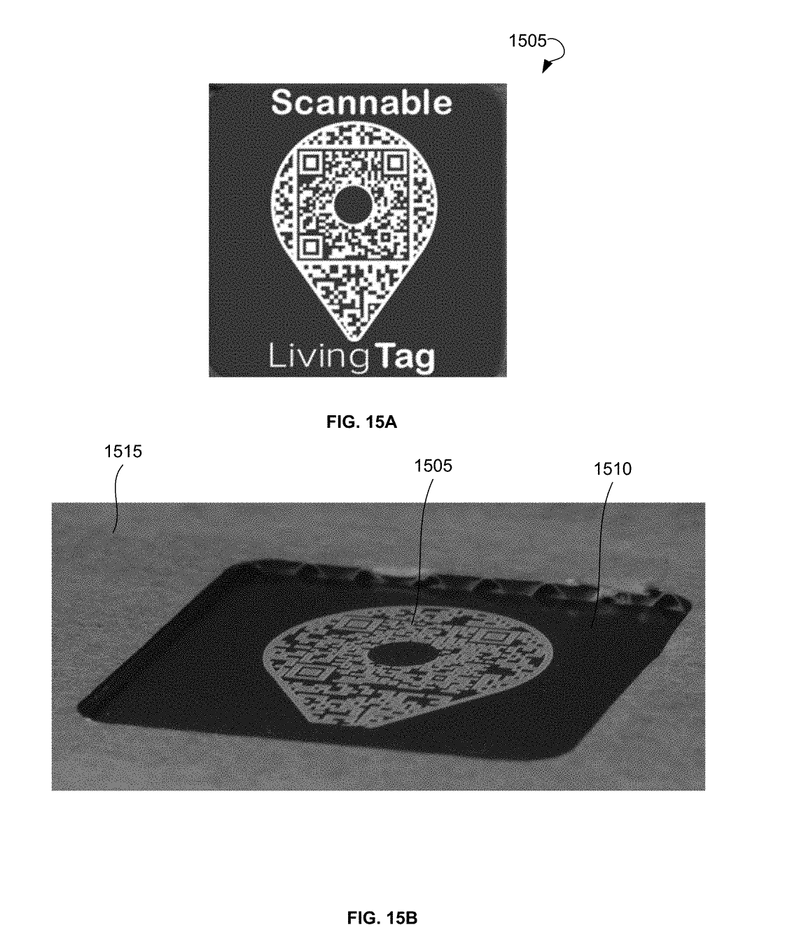

FIG. 15A shows a code 1505 associated with the digital content, according to an example embodiment. The code 1505 may encode a link to a web resource where the digital content is posted, geographical coordinates of the digital content, and any data related to the digital content.

FIG. 15B shows the code 1505 engraved on a plate 1510, such as an aluminum plate, by a laser. The plate 1510 having the code 1505 engraved on it may be attached to any physical object 1515 related to the digital content. The code 1505 engraved on the plate 1510 may be associated with an online community devoted to a deceased person. The plate 1510 having the code 1505 may be attached to a gravestone of the deceased person. When the user is located near the gravestone, the user may scan the code 1505 and the online community associated with the deceased person may be automatically opened on the digital device of the user. The online community associated with the deceased person may be created in honor of the deceased person by a friend, a relative, a colleague, and any other person related to the deceased person.

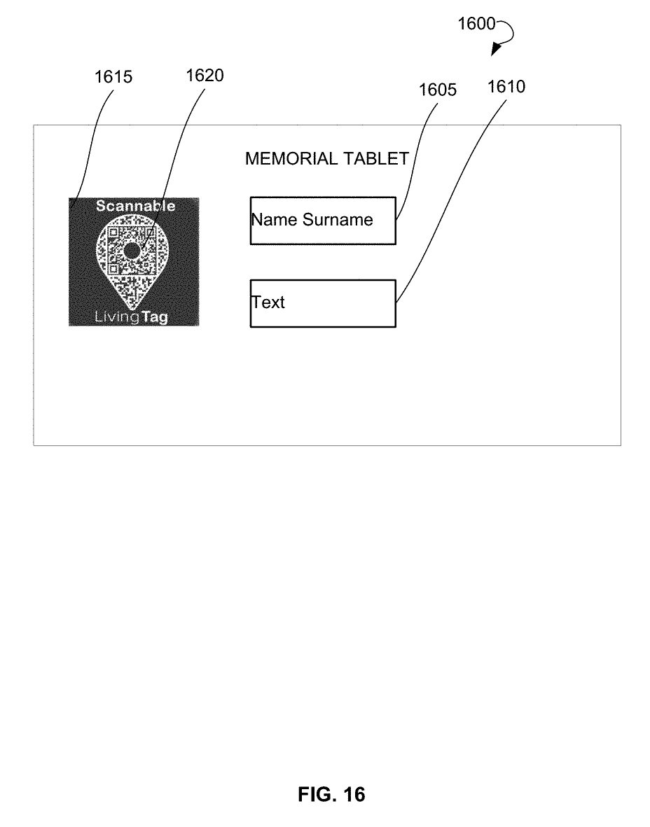

FIG. 16 shows a memorial tablet 1600 created for a person using a physical geotag, according to an example embodiment. The memorial tablet 1600 may include a name of the person 1605, text 1610, and the physical geotag 1615. The physical geotag 1615 may have a code 1620 associated with the digital content. The digital content may relate to the person and may be published on the webpage of the online community devoted to the person.

The physical geotag 1615 may be used to expand the experience of any physical monument or memorial location. The physical geotag 1615 can be placed on memorials (headstone or on a photo album, boats, side of cabin, cars, collars for pets, and the like). The user may also receive a digital version of the physical geotag 1615 (e.g., in PDF format) that can be shared electronically with other users or printed on business cards, used in websites, applications, and the like.

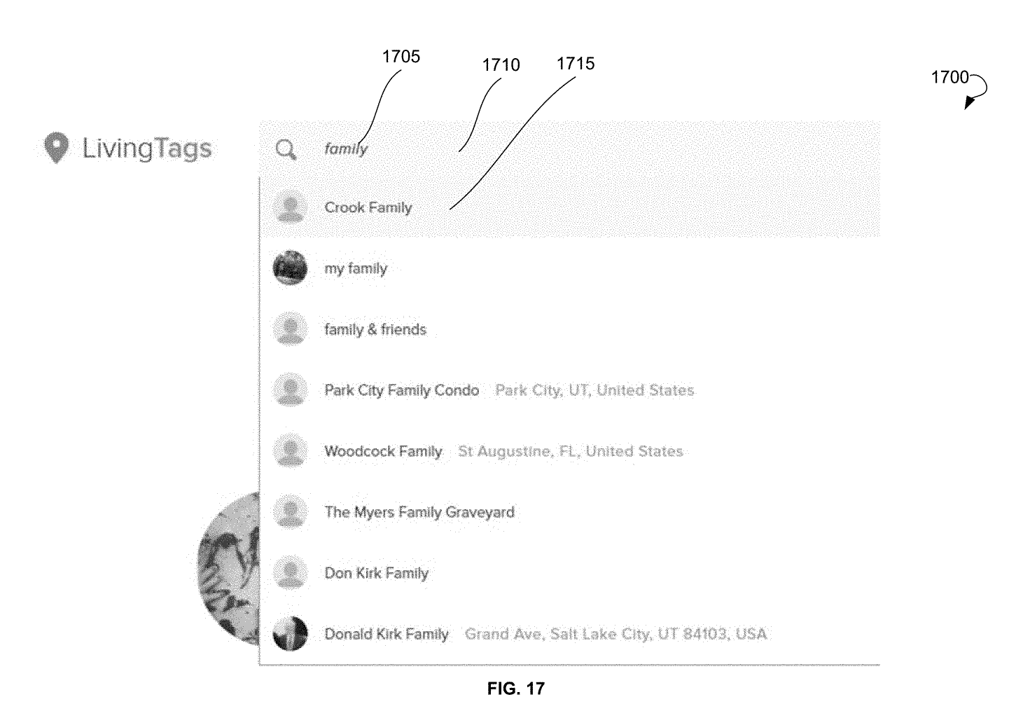

In an example embodiment, the user may search for geotags. FIG. 17 illustrates a user interface 1700 showing an example search performed based on key words. The user may enter a key word 1705 into a search line 1710 and select an online community 1715 that matches the search.

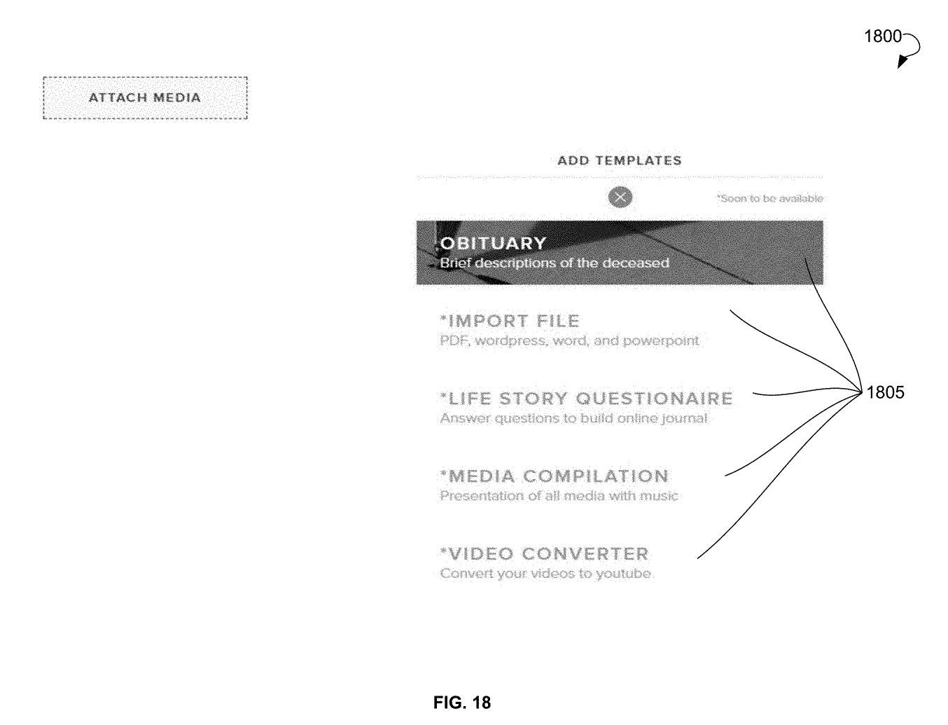

FIG. 18 illustrates a user interface 1800 showing templates 1805 of the online community, according to an example embodiment. The templates 1805 may include an obituary template, an import file template, a life story questionnaire template, a media compilation template, a video converter template, and so forth. For the online community that the user creates, the user can select the template 1805 that suits the needs of the user. The templates 1805 may have preconfigured questions to be answered by the user, preconfigured fields to be filled-in, a preconfigured layout, and the like. The templates 1805 may be targeted business templates, such as designed specifically for realtors, restaurants, and so forth.

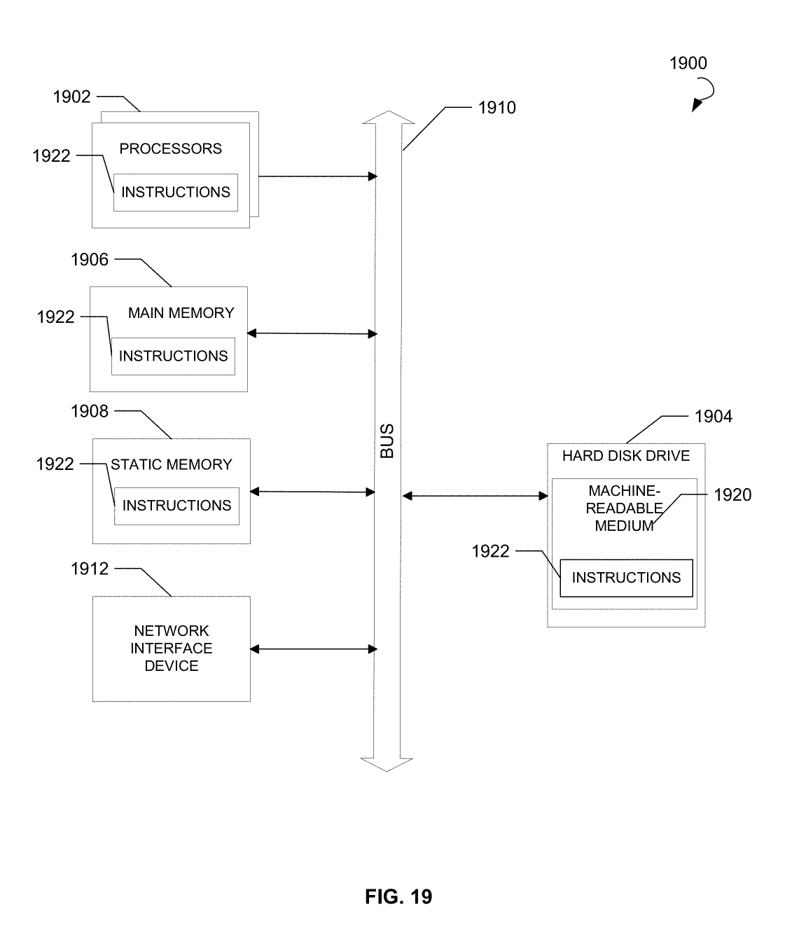

FIG. 19 shows a diagrammatic representation of a computing device for a machine in the exemplary electronic form of a computer system 1900, within which a set of instructions for causing the machine to perform any one or more of the methodologies discussed herein can be executed. In various exemplary embodiments, the machine operates as a standalone device or can be connected (e.g., networked) to other machines. In a networked deployment, the machine can operate in the capacity of a server or a client machine in a server-client network environment, or as a peer machine in a peer-to-peer (or distributed) network environment. The machine can be a PC, a tablet PC, a set-top box, a cellular telephone, a digital camera, a portable music player (e.g., a portable hard drive audio device, such as a Moving Picture Experts Group Audio Layer 3 player), a web appliance, a network router, a switch, a bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1900 includes a processor or multiple processors 1902, a hard disk drive 1904, a main memory 1906, and a static memory 1908, which communicate with each other via a bus 1910. The computer system 1900 may also include a network interface device 1912. The hard disk drive 1904 may include a computer-readable medium 1920, which stores one or more sets of instructions 1922 embodying or utilized by any one or more of the methodologies or functions described herein. The instructions 1922 can also reside, completely or at least partially, within the main memory 1906 and/or within the processors 1902 during execution thereof by the computer system 1900. The main memory 1906 and the processors 1902 also constitute machine-readable media.

While the computer-readable medium 1920 is shown in an exemplary embodiment to be a single medium, the term “computer-readable medium” should be taken to include a single medium or multiple media (e.g., a centralized or distributed database, and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media. Such media can also include, without limitation, hard disks, floppy disks, NAND or NOR flash memory, digital video disks, Random Access Memory (RAM), Read-Only Memory (ROM), and the like.

The exemplary embodiments described herein can be implemented in an operating environment comprising computer-executable instructions (e.g., software) installed on a computer, in hardware, or in a combination of software and hardware. The computer-executable instructions can be written in a computer programming language or can be embodied in firmware logic. If written in a programming language conforming to a recognized standard, such instructions can be executed on a variety of hardware platforms and for interfaces to a variety of operating systems.

In some embodiments, the computer system 1900 may be implemented as a cloud-based computing environment, such as a virtual machine operating within a computing cloud. In other embodiments, the computer system 1900 may itself include a cloud-based computing environment, where the functionalities of the computer system 1900 are executed in a distributed fashion. Thus, the computer system 1900, when configured as a computing cloud, may include pluralities of computing devices in various forms, as will be described in greater detail below.

In general, a cloud-based computing environment is a resource that typically combines the computational power of a large grouping of processors (such as within web servers) and/or that combines the storage capacity of a large grouping of computer memories or storage devices. Systems that provide cloud-based resources may be utilized exclusively by their owners, or such systems may be accessible to outside users who deploy applications within the computing infrastructure to obtain the benefit of large computational or storage resources.

The cloud may be formed, for example, by a network of web servers that comprise a plurality of computing devices, such as a client device, with each server (or at least a plurality thereof) providing processor and/or storage resources. These servers may manage workloads provided by multiple users (e.g., cloud resource consumers or other users). Typically, each user places workload demands upon the cloud that vary in real-time, sometimes dramatically. The nature and extent of these variations typically depends on the type of business associated with the user.

It is noteworthy that any hardware platform suitable for performing the processing described herein is suitable for use with the technology. The terms “computer-readable storage medium” and “computer-readable storage media” as used herein refer to any medium or media that participate in providing instructions to a CPU for execution. Such media can take many forms, including, but not limited to, non-volatile media, volatile media and transmission media. Non-volatile media include, for example, optical or magnetic disks, such as a fixed disk. Volatile media include dynamic memory, such as system RAM. Transmission media include coaxial cables, copper wire, and fiber optics, among others, including the wires that comprise one embodiment of a bus. Transmission media can also take the form of acoustic or light waves, such as those generated during radio frequency (RF) and infrared (IR) data communications. Common forms of computer-readable media include, for example, a floppy disk, a flexible disk, a hard disk, magnetic tape, any other magnetic medium, a CD-ROM disk, digital video disk, any other optical medium, any other physical medium with patterns of marks or holes, a RAM, a Programmable Read-Only Memory (PROM), an Erasable Programmable Read-Only Memory (EPROM), an Electrically Erasable Programmable Read-Only Memory (EEPROM), a FlashEPROM, any other memory chip or data exchange adapter, a carrier wave, or any other medium from which a computer can read.

Thus, systems and methods for associating digital content with geotags are described. Although embodiments have been described with reference to specific exemplary embodiments, it will be evident that various modifications and changes can be made to these exemplary embodiments without departing from the broader spirit and scope of the present application. Accordingly, the specification and drawings are to be regarded in an illustrative rather than a restrictive sense.

What is claimed is:

1. A system for associating digital content with geotags, the system comprising:
a processor configured to:
receive, from a user, the digital content;
receive, from the user, data associated with the digital content, the data including at least a geographical location associated with the digital content;
based on the geographical location, create a geotag associated with the digital content;
determine whether one or more further geotags associated with the user already exist;
based on the determining that the one or more further geotags associated with the user already exist, associate the geotag with the one or more further geotags; and
present a virtual map to the user, the virtual map comprising at least the geotag and the one or more further geotags; and
a database in communication with the processor, the database being configured to store at least the digital content and the data associated with the digital content.

2. The system of claim 1, wherein the virtual map further comprises one or more geotags associated with further users.

3. The system of claim 1, further comprising a manufacturing facility, wherein the processor is further configured to:
receive, from the user, a request for manufacturing a physical geotag associated with the geotag;
based on the request, instruct the manufacturing facility to manufacture the physical geotag associated with the geotag, the manufacturing including:
providing an article; and
physically embedding an identifier associated with the geotag in the article, the physical geotag being the article with the identifier embedded in the article;
provide the physical geotag to the user, wherein the physical geotag is to be attached to a physical object, wherein a geographical location associated with the physical object is the same as the geographical location associated with the digital content.

4. The system of claim 3, wherein the identifier includes at least a code, wherein the code is to be scannable by a digital device, the code being associated with a web resource configured to display the digital content.

5. The system of claim 1, wherein the digital content includes one or more of the following: text, images, graphics, audio files, and video files.

6. The system of claim 1, wherein the data associated with the digital content further include one or more of the following: a description associated with the digital content and data concerning one or more users to be associated with the digital content.

7. The system of claim 1, wherein the receiving, from the user, the data associated with the digital content includes:
in response to the receiving the digital content from the user, prompting the user to select at least the geographical location associated with the digital content; and
receiving, from the user, a selection of the geographical location associated with the digital content.

8. The system of claim 1, wherein the processor is further configured to:
receive, from the user, a selection of a geotag associated with a further user; and
based on the selection, display, to the user, a virtual map associated with the further user, wherein the virtual map is associated with the further user and includes a plurality of geotags associated with the further user.

9. The system of claim 1, wherein the processor is further configured to:
receive, from the user, a selection of a status category to be assigned to the digital content; and
based on the selection, assign the status category to the digital content,
wherein the status category includes one of a private category and a public category, the digital content having the private category being presented for review by the user, the digital content having the public category being presented for review by a plurality of users.

10. The system of claim 1, wherein the processor is further configured to:
continuously receive a geographical location of a digital device associated with the user;
determine that a current geographical location of the digital device associated with the user is in proximity to the geographical location associated with the digital content; and
issue an alert to the digital device of the user, the alert notifying the user that the current geographical location of the digital device is in proximity of the geographical location associated with the digital content.

11. A method for associating digital content with geotags, the method comprising:
receiving, by a processor, from a user, the digital content;
receiving, by the processor, from the user, data associated with the digital content, the data including at least a geographical location associated with the digital content;
based on the geographical location, creating, by the processor, a geotag associated with the digital content;
determining, by the processor, whether one or more further geotags associated with the user already exist;
based on the determining that the one or more further geotags associated with the user already exist, associating, by the processor, the geotag with the one or more further geotags; and
presenting, by the processor, a virtual map to the user, the virtual map comprising at least the geotag and the one or more further geotags.

12. The method of claim 11, further comprising:
based on the determining that the further one or more geotags associated with the user do not exist, designating the geotag as a first geotag associated with the user, wherein the geotag is used for associating with subsequent geotags associated with the user upon receipt, from the user, of further digital content associated with the subsequent geotags.

13. The method of claim 11, further comprising:
receiving, from the user, a request to edit the digital content, wherein the request includes an instruction to perform at least one of the following: crop the digital content, rotate the digital content, change a design of the digital content, change a color of the digital content, and remove a portion of the digital content.

14. The method of claim 11, further comprising:
receiving, from the user, user data; and
based on the user data, creating a user profile associated with the user, wherein the digital content received from the user is associated with the user profile.

15. The method of claim 14, further comprising:
associating the user profile with one or more social media profiles of the user;
receiving, from the user, a request to post the digital content on a timeline associated with the one or more social media profiles;
based on the request, posting the digital content on the timeline associated with the one or more social media profiles of the user.

16. The method of claim 14, further comprising:
creating a webpage associated with the user profile;
posting the digital content received from the user on the webpage; and
presenting the virtual map on the webpage.

17. The method of claim 11, further comprising:
receiving, from the user, a request to create an online community;
in response to the request, creating the online community associated with the user, wherein the creating of the online community includes generating a webpage associated with the online community;
receiving, from the user, data associated with one or more further users to be associated with the online community;
enabling the user and the one or more further users to upload and review digital content to the webpage associated with the online community; and
publishing the digital content uploaded by the user and the one or more further users on the webpage associated with the online community.

18. The method of claim 11, further comprising:
continuously receiving a geographical location of a digital device associated with the user;
determining that a current geographical location of the digital device associated with the user is in proximity to the geographical location associated with the digital content; and
issuing an alert to the digital device of the user, the alert notifying the user that the current geographical location of the digital device is in proximity of the geographical location associated with the digital content.

19. The method of claim 11, wherein the determining whether the one or more further geotags associated with the user already exist includes:
determining user data associated with the user, the user data including at least a unique identifier associated with the user, wherein the digital content is associated with the unique identifier of the user;
based on the unique identifier, searching for the one or more further geotags associated with the unique identifier; and
based on the search, selecting the one or more further geotags.

20. A system for associating digital content with geotags, the system comprising:
a processor configured to:
receive, from a user, the digital content;
receive, from the user, data associated with the digital content, the data including at least a geographical location associated with the digital content;
based on the geographical location, create a geotag associated with the digital content;
determine whether one or more further geotags associated with the user already exist, wherein the determining whether the one or more further geotags associated with the user already exist includes:
determining user data associated with the user, the user data including at least a unique identifier associated with the user, wherein the digital content is associated with the unique identifier of the user;
based on the unique identifier, searching for the one or more further geotags associated with the unique identifier; and
based on the search, selecting the one or more further geotags;
based on the determining that the one or more further geotags associated with the user already exist, associating the geotag with the one or more further geotags; and
presenting a virtual map to the user, the virtual map comprising at least the geotag and the one or more further geotags;
continuously receiving a geographical location of a digital device associated with the user;
determining that a current geographical location of the digital device associated with the user is in proximity to the geographical location associated with the digital content; and
issuing an alert to the digital device of the user, the alert notifying the user that the current geographical location of the digital device is in proximity of the geographical location associated with the digital content; and
a database in communication with the processor, the database being configured to store at least the digital content and the data associated with the digital content.
